(19) United States
(12) Patent Application Publication
(10) Pub. No.: US 2004/0065985 A1
(43) Pub. Date: Apr. 8, 2004

(54) Molding method

(75) Inventor: Daniel R. Johnson, Germantown, OH (US)

Correspondence Address: WEGMAN, HESSLER & VANDERBURG, 6055 ROCKSIDE WOODS BOULEVARD, SUITE 200, CLEVELAND, OH, 44131, US

(73) Assignee: Tokai Kogyo Co., Ltd., Ohbu-City (JP)

(21) Appl. No.: 10/610,205

(22) Filed: Jun. 30, 2003

Related U.S. Application Data
(60) Provisional application No. 60/394,444, filed on Jul. 8, 2002.

(51) Int. Cl. B29C 45/00

(52) U.S. Cl. 264/572

(57) ABSTRACT

Improved method for gas assigned injection molding of automotive moldings and trim parts is disclosed wherein a pressure drop cavity is provided in the mold cavity structure adjacent to the gas channel. Admission of the gas into the gas channel during the molding process creates gas flow into the pressure drop cavity and into the major cavity that forms the general shape and configuration of the part.

### CROSS REFERENCE TO RELATED APPLICATION

This application claims the benefit of U.S. Provisional Application No. 60/394,444, filed Jul 8, 2002.

### FIELD OF THE INVENTION

The invention relates to an improved method of gas assisted injection molding adapted for the formation of elongated automotive mold and trim parts.

### BACKGROUND OF THE INVENTION

Moldings for autos and trucks serve both a decorative and protective function. Recently, these parts have been made via gas assisted injection molding techniques in which, for example, a predetermined amount of the fluent resin is injected into the mold cavity followed by a pressurized gas flow into the cavity through a gas channel to aid in packing or travel of the molten resin uniformly throughout the mold cavity.

At present, it is popular to provide one or more of these elongated gas channels on the backside of the part. Typically, the gas channel extends along the longitudinal axis of the part and, in the finished molded part, may exist in the form of a hollowed rib that may serve as a convenient location for mounting structures such as clips and the like that will be used to fasten the molded part to the frame or body of the car or truck.

Oftentimes, the border between the hollow rib and the surrounding surface of the part is irregular with thick and thin spots formed along the border that significantly deviate from the desired uniform thickness of the part. This phenomenon is currently referred to as “fingering” and is undesirable for several reasons. These “thin” spots provide a potential source for failure of the mechanical attachment between the molding and the body or frame member. Additionally, although the fingering is initially apparent on the back or attachment side of the part adjacent to the gas channel, subsequent painting and baking of the opposing show side of the part may reveal a mirror image of the fingering and result in part rejection for aesthetic reasons.

Accordingly, there is a need in the art for an improved molding method and mold cavity structure in which this tendency toward formation of non-uniform thicknesses along the gas channel or fingering as it is called, may be minimized.

### SUMMARY OF THE INVENTION

The invention is accordingly directed to an improved gas assisted molding method and mold cavity structure adapted therefore that involve utilization of an enlarged pressure drop chamber. The pressure drop chamber is located adjacent the gas inlet aperture in the mold and is in communication with the gas channel cavity and major mold cavity; the latter of which, upon molding, provides the overall shape and contour of the part. The pressure drop chamber provides an increased volume area of the major mold cavity.

Although applicants are not to be bound to any particular theory of operation, it is thought that the initial charge of gas flowing into the mold cavity following injection of the desired amount of molten resin therein, is directed into this pressure drop chamber followed by travel of the gas throughout the major mold cavity and along the gas channel in such direction as to uniformly pack the resin throughout the cavity.

Preliminary results have indicated that gas assisted molding techniques that are supplemented by the provision of the pressure drop chamber in accordance with the invention result in production of highly uniform parts in which the part surfaces surrounding the channel rib are smooth and provide distinct edge boundaries with substantially no fingering.

The invention will be further described in conjunction with the appended drawings and following detailed description.

### BRIEF DESCRIPTION OF THE DRAWINGS

FIG. 1 is a schematic plan view of the backside of an automotive molding in accordance with the invention;

FIG. 2 is a schematic cross-sectional view of a mold cavity utilized to mold the part shown in FIG. 1; and

FIG. 3 is a schematic cross-sectional view of the mold cavity shown in FIG. 2, taken along the plane shown by the lines and arrows 3-3 in FIG. 2.

### DETAILED DESCRIPTION OF THE PREFERRED EMBODIMENT

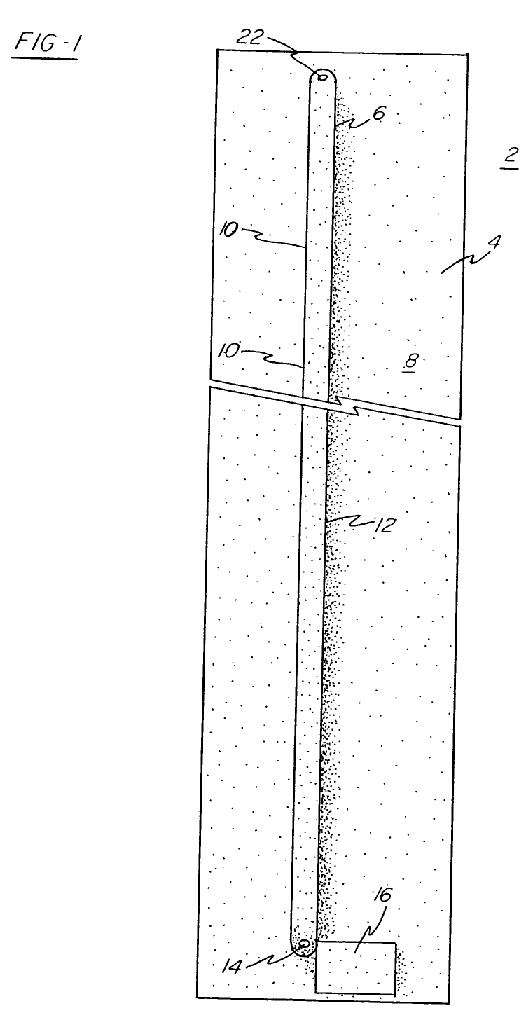

Turning now to FIG. 1 of the drawings, there is shown an elongated molding 2 that is adapted for attachment to an auto or truck body or frame member. Moldings of the general type depicted herein are shown also in U.S. Pat. No. 5,660,897 (Maki), the entire disclosure of which is incorporated herein by reference.

In FIG. 1, the backside 4 portion of the molding is shown. It is to be understood that this particular side is the part side that will be attached contiguously to the frame or body member of the auto or truck. In addition to the generally planar backsurface of the molding, an upstanding elongated rib or gas channel member 6 is provided. The gas channel extends along the longitudinal axis of the elongated molding and, as shown, is in the general form of an enclosed hollowed, elongated rib having upstanding walls that extend above the generally planar major surface 8 of the backside of the molding. The longitudinal edges or walls 10, 12 of the gas channel extend upwardly from the planar surface 8. Heretofore, upon molding, “fingering” or non-uniform thick and thin spots would, in some cases, be produced along the interface of the major surface 8, and longitudinal edges 10, 12.

A gas injection inlet is provided 14 at one longitudinal end of the gas channel, and a gas egress aperture 22 is provided at the opposite end of the gas channel. As shown in FIG. 1, an increased thickness portion of the surface is shown at 16. It is noted that this surface 16 is contiguous to the gas channel and placed proximate the gas inlet aperture 14.

As shall be explained hereinafter, the increased thickness portion 16 of the elongated part is formed by a specifically designed pressure drop chamber formed in the mold cavity. We have found that the utilization of this pressure drop chamber is helpful in minimizing the “fingering” problem that, in some cases, was presented along the longitudinal edges 10, 12 of the rib as those edges met the planar major surface 8 of the molding 2.

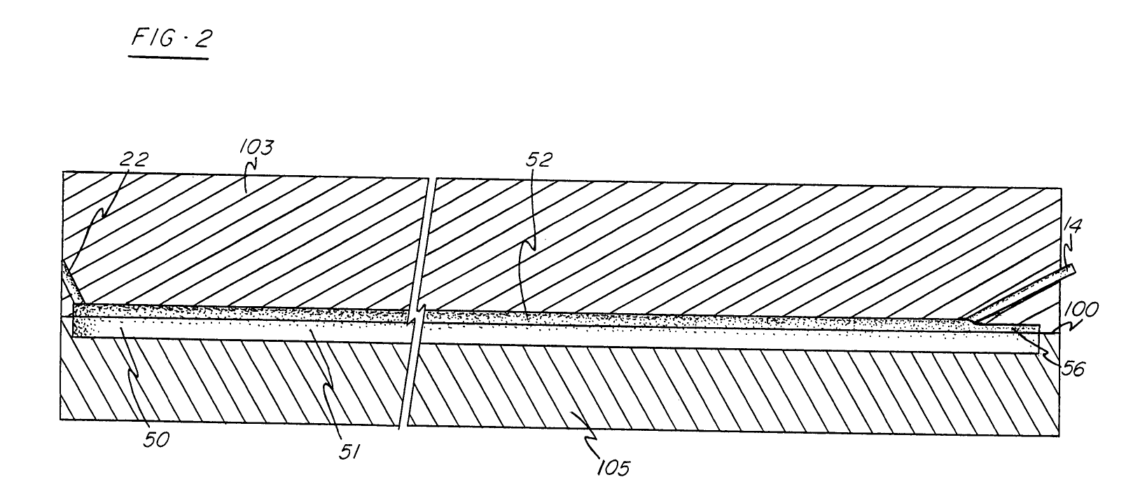

Turning now to FIG. 2 of the drawings, there is shown a mold cavity 50 in accordance with the invention which is utilized in the molding production of the part shown in FIG. 1. The mold cavity comprises a major cavity 51 which defines the general desired dimensions and contour of the part. Although the part illustrated herein is rectangular in shape and has a generally planar surface of generally uniform thickness, the artisan will appreciate that a plethora of differently shaped molded trim parts may benefit from the invention. For example, many elongated rocker panels and the like are not planar but have a general curvature or radius across the width. Additionally, varying thicknesses may be imparted such as the provision of thickened ribs or the like extending parallel to or transverse to the longitudinal axis of the part.

As shown in the FIG. 2 view, the gas channel cavity 52 is a portion of the major cavity 51 and upon completion of the molding process provides for the formation of the elevated height gas channel as shown in FIG. 1 and as can be seen in U.S. Pat. No. 5,660,897. Adjacent the gas inlet 14, pressure drop chamber 56 is provided. It can be seen here that the pressure drop chamber 56 provides an increase in volume over the volume of the major cavity in the vicinity of the gas inlet. Stated differently, the pressure drop chamber 56 has a height that is greater than the height of the major cavity height 51. Part line 100 is provided in the mold as is conventional to allow separation of the respective mold halves 103, 105.

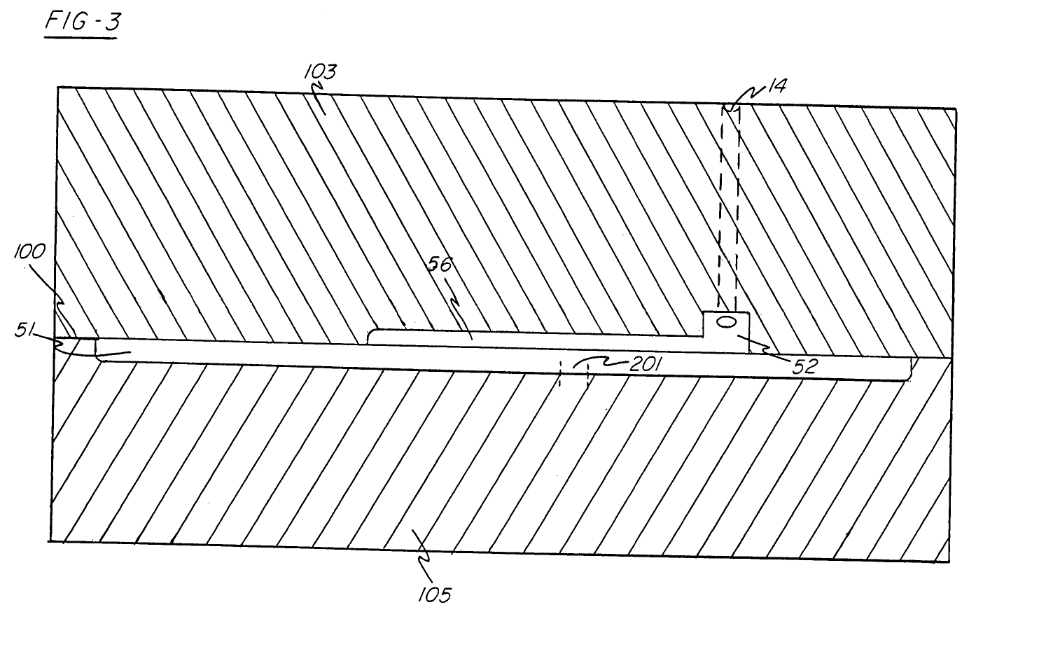

Turning now to FIG. 3 of the drawings, it can be seen that gas inlet 14 is in communication with the gas channel and also communicates with the pressure drop chamber 56 which is laterally offset, as shown in FIG. 3, from the gas channel. As shown, the pressure drop cavity extends laterally away from the gas channel cavity and overlies a portion of the major cavity 51 proximate the gas inlet.

The reference number 201 is used to designate a given unit area measured along the surface of cavity 51 in mold halve 105. For example, at the area 201, the pressure drop chamber provides an increased volume compared to the major cavity volume at that area 201. Stated differently, the pressure drop cavity 56 provides an increase in height (vertically measured in FIG. 3) over the height of the cavity 51 at the area designated as 201.

In operation, a requisite quantity of molten resin is first injected into the cavity 50 through appropriate gating or via a runner. The amount of resin is calculated as the amount needed to densely pack the major chamber 51 and provide for the walls of the rib in the part. At present, it is preferred to admit the plastic through the inlet 14 that is also used for gas admission. As to the plastic that may be used, the artisan will appreciate that a host of different choices are available. Exemplary plastics include the thermoplastic resins such as thermoplastic olefins and styrenic polymers such as acrylonitrile butadiene styrene copolymers. Additional suitable thermoplastic materials may include, for example, polyvinyl chloride, polycarbonate, polystyrene, polyethylene, polypropylene, polyethylene terephthalate, nylon, and RIM urethanes. Polyolefin homopolymers and copolymers are inexpensive thermoplastic resins which have excellent molding properties and may also be mentioned as being suitable for use. Polypropylene is presently preferred.

After the desired shot or quantity of molten resin is injected into the mold cavity, a pressurized flow of inert gas, such as nitrogen gas, is admitted through the aperture 14 so as to help pack the resin uniformly throughout the mold cavity 50. The gas may be admitted at pressures between about 1,000 and 6,000 psi. Due to the increased volume presented by the presence of the pressure drop cavity 56, it is thought that the gas, when initially admitted into the mold cavity, will be directed to the pressure drop chamber 56 and then perform its desired packing function of the resin throughout the mold cavity.

The above injection molding process is known generally to those with skill in the art of gas-assisted injection molding as “full shot” injection molding. Alternatively, the improved part of the instant invention may be molded by means of a “short shot” method wherein a predetermined amount of thermoplastic material is first injected into the mold cavity, and then a predetermined amount of a gas is injected simultaneously with the remaining amount of thermoplastic material necessary to fill out the mold. While nitrogen is the preferred gas for use in gas-assisted injection molding, other inert or relatively non-reactive gases may be used as well.

Preliminary results have shown that the “fingering” tendency shown in some of the prior art methods is minimized by use of the pressure drop chamber 56 that is located in proximity to the gas channel and gas inlet.

While the methods and structures herein described constitute preferred embodiments of this invention, it is to be understood that the invention is not limited to these precise methods and structures and that changes may be made without departing from the scope of the invention, which is defined in the appended claims.

What is claimed is:

1. Improved method for molding an automotive molding or trim part having a gas channel formed therein, said method comprising:
providing a mold cavity having a desired thickness and contour;
providing a gas channel cavity in communication with said mold cavity;
providing a gas inlet aperture in communication with said gas channel cavity;
providing a pressure drop chamber in said mold cavity adjacent to said gas inlet and in communication with said gas channel cavity;
injecting a predetermined amount of molten resin into said mold cavity; and
injecting a flow of pressurized gas through said gas inlet aperture into said pressure drop chamber and said mold cavity to pack said molten resin throughout said mold cavity.

2. Method as recited in claim 1 wherein said gas is injected at a pressure of about 1,000-about 6,000 psi.

3. Method as recited in claim 1 wherein said gas is injected subsequent to said step of injecting a predetermined amount of molten resin into said mold cavity.

4. Method for molding an automotive molding or trim part, said method comprising:
providing a mold having a mold cavity including a major cavity portion adapted to define the general contour of said molding or trim part;
providing a gas channel cavity in communication with said major cavity portion;
providing a gas inlet in communication with said gas channel;
providing a pressure drop cavity in communication with said major cavity portion and said gas inlet, said pressure drop cavity defining an increased volume area of the mold cavity proximate to said gas inlet;
injecting a predetermined amount of a fluent plastic into said major cavity portion; and
injecting a flow of pressurized gas through said gas channel inlet into communication with said pressure drop chamber and said major cavity portion to uniformly pack said fluent plastic throughout said major cavity.

5. Method for molding as recited in claim 4 wherein said pressure drop cavity extends laterally away from said gas channel cavity and overlies a portion of said major cavity portion proximate to said gas inlet.

6. Method as recited in claim 5 wherein said gas is injected subsequent to injection of said plastic.

7. Method as recited in claim 6 wherein said fluent plastic comprises a thermoplastic polymer.

8. Method as recited in claim 7 wherein said thermoplastic polymer comprises a polyolefin.

9. Method as recited in claim 8 wherein said polyolefin is polyethylene or polypropylene.

10. Method as recited in claim 8 wherein said polyolefin is poly propylene.

11. Method as recited in claim 9 wherein said gas is injected at a pressure of about 1,000-6,000 psi.
